(19) United States
(12) Patent Application Publication
(10) Pub. No.: US 2026/0296287 A1
(43) Pub. Date: Oct. 1, 2026

(54) VEHICLE EGRESS AID

(71) Applicant: NISSAN NORTH AMERICA, INC., Franklin, TN (US)

(72) Inventor: Christian Donald SPENCER, Beverly Hills, MI (US)

(21) Appl. No.: 19/097,648

(22) Filed: Apr. 1, 2025

(51) Int. Cl. B60N 3/02

(52) U.S. Cl. CPC B60N 3/026; B60N 3/023

(57) ABSTRACT

A vehicle egress aid includes a handle a locking member. The handle member having a gripping portion and a striker engagement portion. The striker engagement portion being configured to be received within a wire loop of a striker. The locking member having an actuating portion and a locking portion. The locking portion having a locking surface. The locking member being movably coupled relative to the handle member between a locked position and an unlocked position. The locking surface of the locking portion and the striker engagement portion being configured to be disposed on opposite sides of the wire loop in the locked position to prevent the striker engagement portion from being removed from within the wire loop in an installed state where the vehicle egress aid is locked to the striker.

### BACKGROUND

### Technical Field

The present disclosure generally relates to a vehicle egress aid. More specifically, the present disclosure relates to a vehicle egress aid that functions as a handle when attached to a vehicle striker.

### Background Information

Vehicle egress aids are often used as handles to assist a person as they enter and exit a vehicle. These handles can provide support for elderly people, people with less strength and others. One example of a vehicle egress aid is disclosed in U.S. Pat. No. 9,296,323 B2 , which is designed to engage a vehicle striker.

### SUMMARY

Generally, the present disclosure is directed to various features of a vehicle egress aid that preferably attaches to a vehicle striker.

It has been discovered that vehicle egress aids can be designed to be more rigidly attached to vehicles and to be easier to attach to the vehicle.

In view of the state of the known technology, one aspect of the present disclosure is to provide a vehicle egress aid fundamentally includes a handle and a locking member. The handle member has a gripping portion and a striker engagement portion. The striker engagement portion is configured to be received within a wire loop of a striker. The locking member has an actuating portion and a locking portion. The locking portion has a locking surface. The locking member is movably coupled relative to the handle member between a locked position and an unlocked position. The locking surface of the locking portion and the striker engagement portion are configured to be disposed on opposite sides of the wire loop in the locked position to prevent the striker engagement portion from being removed from within the wire loop in an installed state where the vehicle egress aid is locked to the striker.

Also, other objects, features, aspects and advantages of the disclosed vehicle egress aid will become apparent to those skilled in the art from the following detailed description, which, taken in conjunction with the annexed drawings, discloses preferred embodiments of the vehicle egress aid.

### BRIEF DESCRIPTION OF THE DRAWINGS

Referring now to the attached drawings which form a part of this original disclosure, illustrative embodiments are shown.

FIG. 1 is a perspective view of a portion of a vehicle having a vehicle egress aid in accordance with a first embodiment.

FIG. 2 is a perspective view of the vehicle egress aid in the locked position and just prior to being installed to the striker of a vehicle in accordance with the first embodiment.

FIG. 3 is a perspective view of the vehicle egress aid being held in the unlocked position in accordance with the first embodiment.

FIG. 4 is another perspective view of the vehicle egress aid in the locked position in accordance with the first embodiment.

FIG. 5 is an exploded perspective view of the vehicle egress aid in accordance with the first embodiment.

FIG. 6 is an elevational view of the vehicle egress aid in the locked position in accordance with the first embodiment.

FIG. 7 is an elevational view of the vehicle egress aid in the unlocked position in accordance with the first embodiment.

FIG. 8 is an exploded elevational view of the vehicle egress aid in accordance with the first embodiment.

FIG. 9 is an elevational view of a striker and a vehicle egress aid in the locked position in accordance with a second embodiment in which the vehicle egress aid is locked to a striker.

FIG. 10 is an elevational view of a striker and a vehicle egress aid in the unlocked position in accordance with a second embodiment in which the vehicle egress aid is not locked to the striker.

FIG. 11 is an elevational view of a striker and a vehicle egress aid in the locked position in accordance with a third embodiment in which the vehicle egress aid is locked to a striker.

FIG. 12 is an exploded perspective view of the vehicle egress aid in accordance with the third embodiment.

FIG. 13 is an elevational view of the striker and the vehicle egress aid in the unlocked position in accordance with the third embodiment in which the vehicle egress aid is not locked to the striker.

### DETAILED DESCRIPTION OF EMBODIMENTS

Selected embodiments will now be explained with reference to the drawings. It will be apparent to those skilled in the art from this disclosure that the following descriptions of the embodiments are provided for illustration only and not for the purpose of limiting the invention as defined by the appended claims and their equivalents.

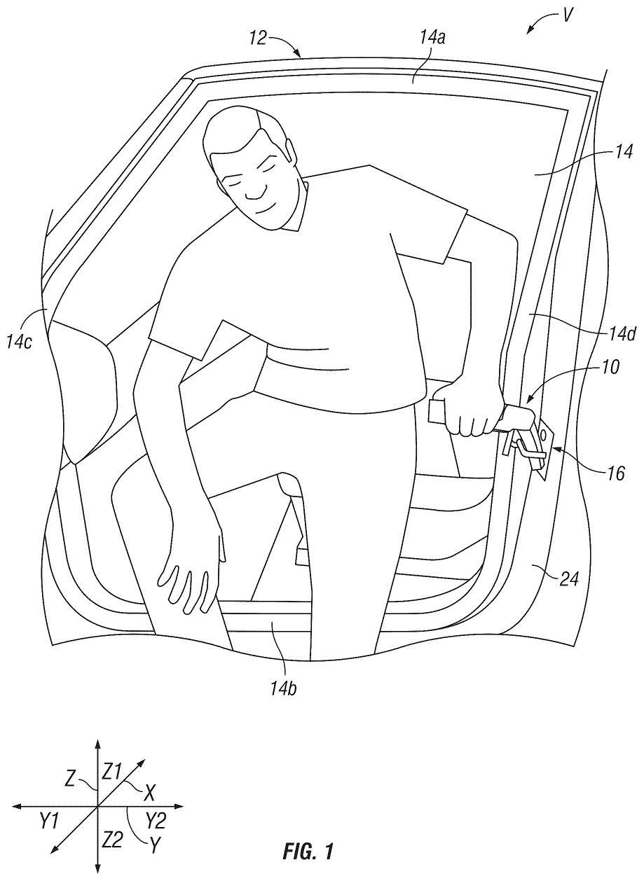

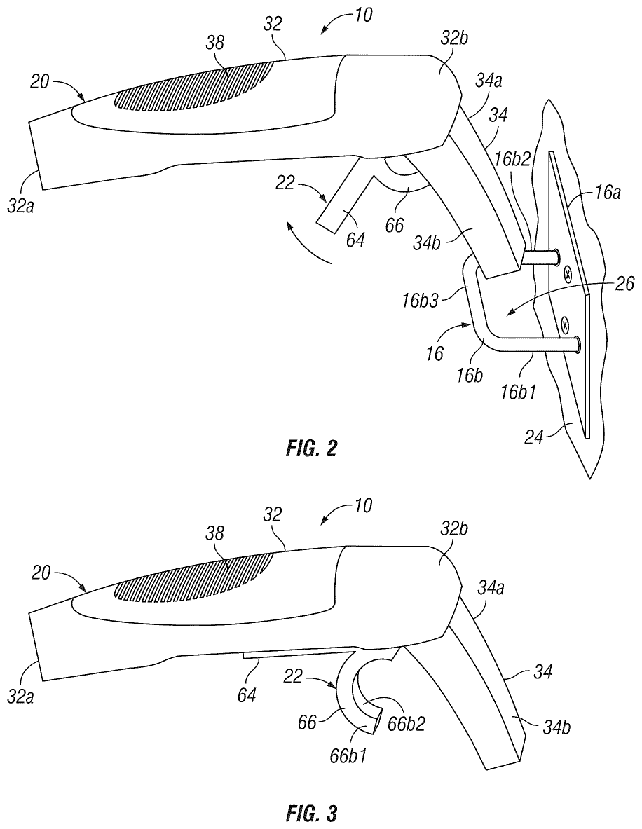

Referring initially to FIG. 1, a perspective view of a portion of a vehicle V is illustrated in which a person uses a vehicle egress aid 10 to exit the vehicle V in accordance with a first embodiment. The vehicle V includes, among other things, a vehicle body structure 12 that includes a door opening 14, and a striker 16. As seen in FIG. 2, in the first embodiment, the vehicle egress aid 10 fundamentally includes a handle member 20 and a locking member 22. In addition, the vehicle V includes many conventional features, structures and components, such as a door pivotally mounted within the door opening 14. These conventional features, structures and components are well known in the vehicle field. Thus, further description of the vehicle V is omitted for the sake of brevity.

As seen in FIG. 1, fundamentally, the vehicle 10 has a lateral direction X, a lengthwise direction Y and a vertical direction Z (see FIG. 1). The lengthwise direction Y includes a forward direction Y1 and the rearward direction Y2 (see FIG. 1). The vertical direction Z includes an upward direction Z1 and a downward direction Z2 (see FIG. 1).

As seen in FIG. 1, the door opening 14 of the vehicle body structure 12 is defined by an upper portion 14a, a lower portion 14b, a first side portion 14c, a second side portion 14d. The striker 16 is attached to the second side portion 14d in a conventional manner (e.g., by a pair of fasteners). The upper portion 14a is also called a roof structure and the lower portion 14b is also called a sill structure. The first side portion 14c is also called a first pillar and the second side portion 14d is also called a second pillar. The first pillar can be the A-pillar, B-pillar or C-pillar. The second pillar can be the B-pillar or C-pillar. Here, for example, the first side portion 14c is an A-pillar, and the second side portion 14d is a B-pillar. The second side portion 14d includes an upright surface 24. Stated differently, the vehicle body structure 12 has the upright surface 24 partially defining the door opening 14. More specifically, the upright surface 24 is forwardly facing. The space between the first side portion 14c and the second side portion 14d defines an interior of the door opening 14. A door (not shown) is pivotally attached to the first side portion 14c and has a latch that is configured to engage the striker 16 when the door is in the closed position.

Referring to FIGS. 1 and 2, the striker 16 is attached to the vehicle body structure 12 within the door opening 14 as mentioned above. The striker 16 includes a mounting plate 16a and a wire loop 16b. The mounting plate 16a attaches to the upright surface 24 of the second side portion 14b. In particular, fasteners attach the mounting plate 16a to the upright surface 24.

The wire loop 16b includes a first wire portion 16b1, a second wire portion 16b2 and a bridging wire portion 16b3. The bridging wire portion 16b3 connects the first wire portion 16b1 and the second wire portion 16b2. The ends of the first wire portion 16b1 and the second wire portion 16b2 are, for example, connect to openings of the mounting plate 16a in a conventional manner. The first wire portion 16b1 and second wire portion 16b2 extend away from the mounting plate 16a. More specifically, the first wire portion 16b1 and the second wire portion extend into the interior of the door opening 14. The wire loop 16b and the mounting plate 16a define a wire opening 26.

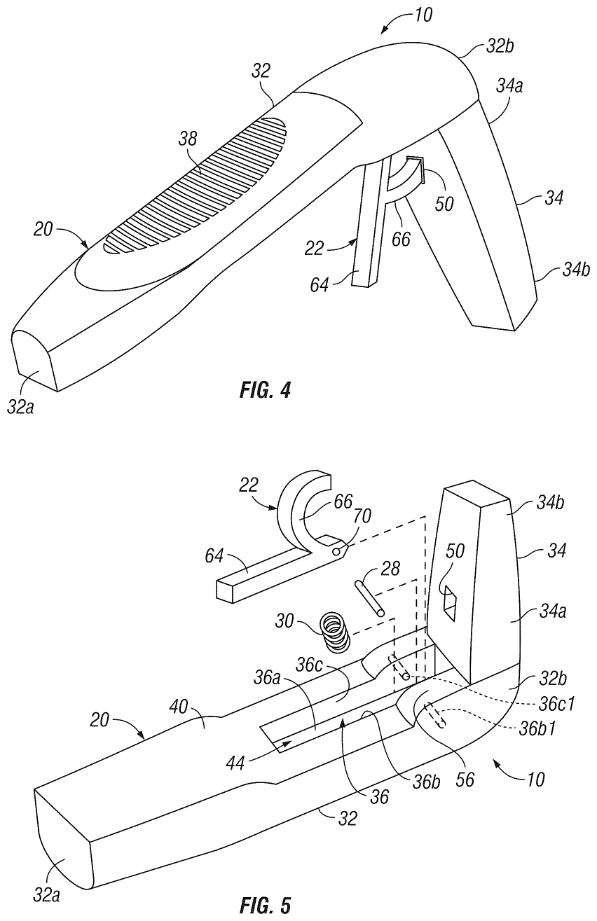

The vehicle egress aid 10 (can also be referred to as a handle structure 10) is now described with reference to FIGS. 2-8. As described above, the vehicle egress aid 10 fundamentally includes a handle member 20 and a locking member 22. The vehicle egress aid 10 further includes a pivot shaft 28 and a biasing member 30. Fundamentally, the locking member 22 is pivotally attached to the handle member 20 by the pivot shaft 28. The biasing member 30 applies a biasing force on the locking member 22 to bias the locking member 22 towards the locked position.

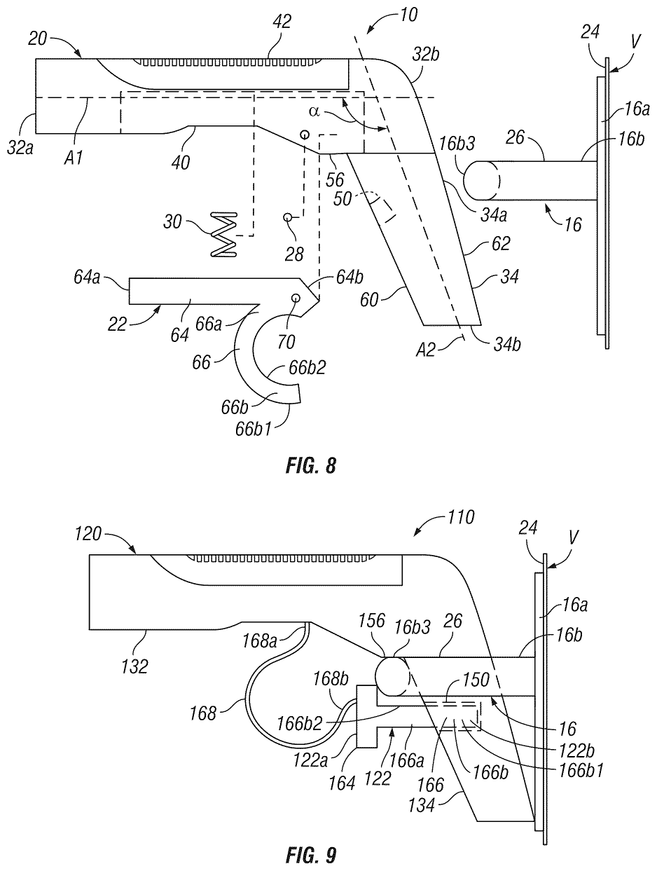

Referring to FIGS. 2-8, the handle member 20 has a gripping portion 32 and a striker engagement portion 34. The striker engagement portion 34 is coupled to the gripping portion 32. The gripping portion 32 has a first end portion 32a and a second end portion 32b. The striker engagement portion 34 has a first end portion 34a and a second end portion 34b. As seen in FIG. 8, a first axis A1 of the handle member 20 extends from the first end portion 32a of the gripping portion 32 to the second end portion 32b of the gripping portion 32. A second axis A2 of the handle member 20 extends from the first end portion 34a of the striker engagement portion 34 to the second end portion 34b of the striker engagement portion 34. An angle α is defined between the first axis A1 and the second axis A2. The angle α is between 60 degrees and 120 degrees. More preferably, the first angle α is between 70 degrees and 110 degrees. Even more preferably, the angle α is 110 degrees. In other words, the handle member 20 has an overall L shape. Stated differently, the gripping portion 32 and the striker engagement portion 34 have an overall L shape. In other words, the striker engagement portion 34 extends transversely to the gripping portion 32. Here, the handle member 20 is made of a rigid material such as steel, plastic etc. The handle member 20 is a single, monolithic part.

The gripping portion 32 has a second opening 36 and a gripping feature 38. The first end portion 32a of the gripping portion 32 extends from the second side portion 14d of the door opening 14 into the interior of the door opening 14 in the case where the striker engagement portion 34 is engaged with the striker 16 in the installed state. The second end portion 32b is coupled to the striker engagement portion 34. The gripping portion 32 has a substantially linear shape. The gripping portion 32 has an interior surface 40 and an exterior surface 42. The interior surface 40 faces the angle α. The exterior surface 42 faces away from the angle α. The interior surface 40 of the gripping portion 32 has the second opening 36.

Referring to FIG. 5, the second opening 36 of the gripping portion 32 is defined by a base wall 36a, a first wall 36b and a second wall 36c. A gap between the base wall 36a and the first wall 36b defines a cavity 44. Stated differently, the gripping portion 32 has the base wall 36a and the first wall 36b extends from the base wall 36a to define the cavity 44. Further, the first wall 36b and the second wall 36c extend away from the base wall 36a. In other words, the handle member 20 has the second opening 36c1 extending transversely to the gripping portion 32. The first wall 36b has a first pivot opening 36b1 and the second wall 36c has a second pivot opening 36c1. Further, the gripping portion 32 has the second wall 36c extending from the base wall 36a to further define the cavity 44. Alternatively, the pivot shaft 28 can be monolithically formed with the first wall 36b or the second wall 36c.

The gripping feature 38 provides a surface for the user's hand to grab the gripping portion 32 and prevents the user's hand from slipping on the gripping portion 32. The gripping features 38 can include a rubber pad, knurling, ribs, etc.

Referring to FIGS. 2-5, the striker engagement portion 34 has a first opening 50, a stop surface 56, an interior surface 60 and an exterior surface 62. The first opening 50 receives the locking member 22 in the locked position. The stop surface 56 is configured to contact the striker 16 in the locked position. The interior surface 60 is configured to engage the wire loop 16b where the locking member 22 is in the locked position. The exterior surface 62 is configured to engage the mounting plate 16a. The interior surface 60 faces the angle α. The exterior surface 62 faces away from the angle α. The interior surface 60 of the striker engagement portion 34 has the first opening 50. Alternatively, the exterior surface 62 is configured to engage the upright surface 24. The first end portion 34a of the striker engagement portion 34 is coupled to the second end portion 32b of the gripping portion 32. The second end portion 34b of the striker engagement portion 34 is dimensioned to be received within the wire opening 26 of the striker 16. Stated differently, the striker engagement portion 34 is configured to be received within the wire loop 16b of the striker 16. The striker engagement portion 34 has a generally linear shape.

Referring to FIGS. 5-8, the locking member 22 has an actuating portion 64, a locking portion 66 and the pivot shaft 28. The actuating portion 64 has a first end portion 64a and a second end portion 64b. The second end portion 64b of the actuating portion 64 is attached to the second end portion 32b of the gripping portion 32 of the handle member 20. The second end portion 64b of the actuating portion 64 includes a third pivot opening 70. The cavity 44 is configured to at least partially receive the actuating portion 64 in the locked position. Stated differently, the gripping portion 32 has the cavity 44, which is configured to at least partially receive the actuating portion 64 in the locked position. The actuating portion 64 has a generally linear shape.

The locking portion 66 has a first end portion 66a and a second end portion 66b. The locking portion 66 includes a protrusion 66b1 and a locking surface 66b2. The first end portion 66a of the locking portion 66 is coupled to the second end portion 64b of the actuating portion 64. The second end portion 66b of the locking portion 66 defines the protrusion 66b1. The protrusion 66b1 is received by the first opening 50 in the striker engaging portion 34. In other words, the first opening 50 is configured to receive the protrusion 66b1 of the locking portion 66. The locking surface 66b2 is defined by a surface of the second end portion 66b of the locking portion 66 that faces the wire loop 16b in the installed state. Here, the locking member 22 is made of a rigid material such as steel, plastic etc. The locking portion 66 has a generally curved shape. The locking member 22 is a single, monolithic part.

The pivot shaft 28 is received by the first pivot opening 36b1, the second pivot opening 36c1 and the third pivot opening 70. As described above, the locking member 22 pivots about the pivot shaft 28 relative to the handle member 20.

Referring to FIGS. 5-8, the biasing member 30 is disposed between the gripping portion 32 and the actuating portion 64. Stated differently, the biasing member 30 is disposed between the handle member 20 and the locking member 22. As described above, the biasing member 30 applies a biasing force on the locking member 22 to bias the locking member 22 towards the locked position. In other words, the locking portion 66 is spring biased toward the striker engagement portion 34. Further, the biasing member 30 biases the actuating portion 64 away from the gripping portion 32. The biasing member 30 can be a coil spring, torsion spring, or another type of spring.

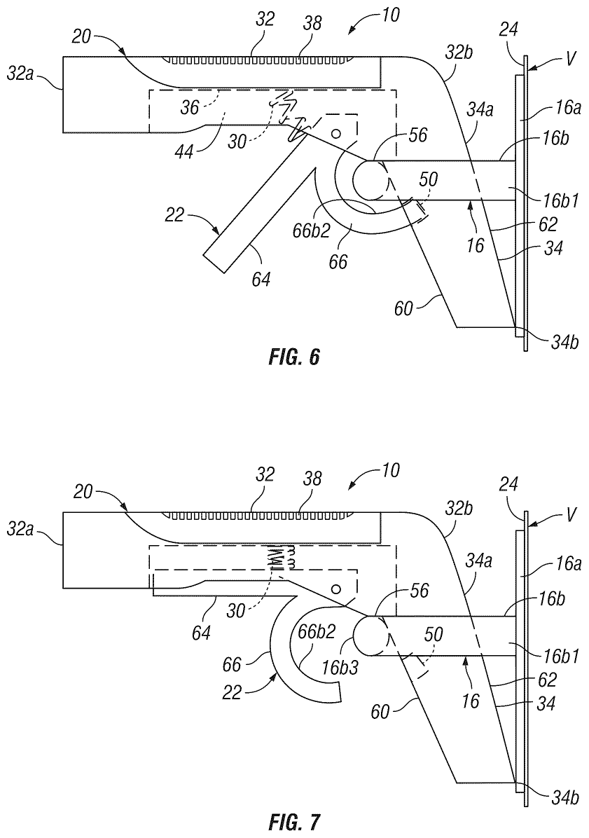

Referring to FIGS. 6 and 7, the locking member 22 has a locked position and an unlocked position. In other words, the locking member 22 is movably coupled relative to the handle member 20 between a locked position and an unlocked position. More specifically, the locking member 22 is pivotally mounted relative to the handle member 20 on the pivot shaft 28 between the locked position and the unlocked position. In the locked position (see FIG. 6), the biasing member 30 biases the actuating portion 64 away from the gripping portion 32. The biasing member 30 biases the locking portion 66 toward the striker engagement portion 34 in the locked position. In the unlocked position (see FIG. 7), the biasing member 30 is compressed by the user to move the actuating portion 64 toward the gripping portion 32. The locking portion 66 is spaced apart from the striker engagement portion 34 in the unlocked position.

Referring to FIGS. 6 and 7, in operation, the user unlocks the vehicle egress aid 10 by moving the actuating portion 64 of the locking member 22 toward the gripping portion 32 of the handle member 20 to compress the biasing member 30. The protrusion 66b1 of the locking portion 66 is removed from the first opening 50 of the striker engagement portion 34. In other words, the locking portion 66 is spaced apart from the striker engagement portion 34 in the unlocked position. The user inserts the striker engagement portion 34 into the wire opening 26 of the striker 16. The stop surface 56 of the handle member 20 faces the wire loop 16b. More specifically, the stop surface 56 of the handle member 20 is disposed above the wire loop 16b. The user releases the actuation portion 64 to decompress the biasing member 30 allowing the protrusion 66b1 to be received by the first opening 50 of the striker engagement portion 34. The locking surface 66b2 and the stop surface 56 are on oppose sides of the wire loop 16b. Stated differently, the locking surface 66b2 of the locking portion 66 and the handle member 20 are configured to be disposed on opposite sides of the wire loop 16b in the locked position to prevent the striker engagement portion 34 from being removed from within the wire loop 26 in an installed state where the vehicle egress aid 10 is locked to the striker 16. In other words, the stop surface 56 is configured to contact an upper surface of the bridging portion 16b3 of the striker 16, and the locking surface 66b2 is configured to face a lower surface of the bridging portion 16b3 of the striker 16 in the locked position and in the installed state. Alternatively, while FIG. 6 shows the locking surface 66b2 spaced apart from the wire loop 16b, the locking surface 66b2 can be configured to contact the lower surface of the bridging portion 16b3 in the locked position and in the installed state. Alternatively, while FIG. 6 shows the stop surface 56 contacting the upper surface of the wire loop 16b in the installed state, the stop surface 56 can be spaced apart from the wire loop 16b in the installed state.

### Second Embodiment

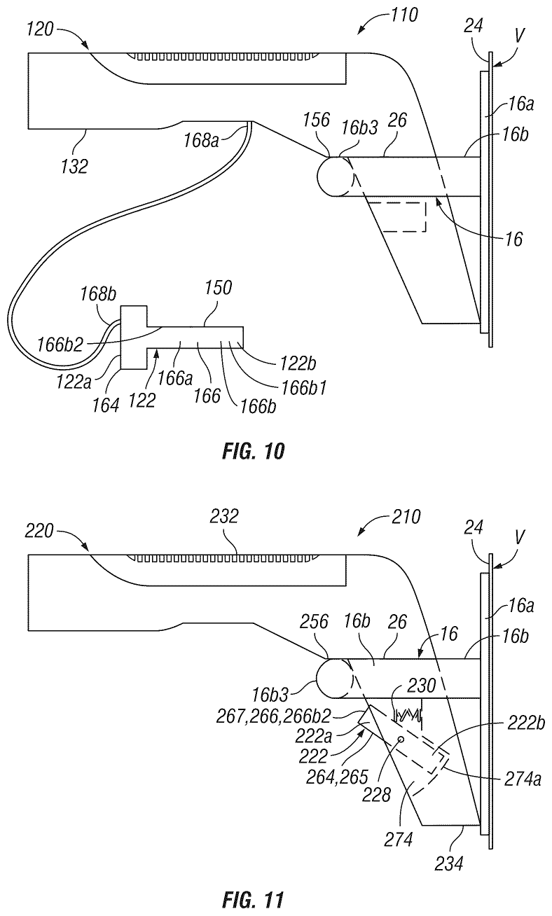

Referring now to FIGS. 9 and 10, a vehicle egress aid 110 in accordance with a second embodiment will now be explained. The vehicle egress aid 110 is used to engage the striker 16 of the vehicle V in a similar manner as the vehicle egress aid 10 discussed above. In view of the similarity between the first and second embodiments, the parts of the second embodiment that are identical or identical in function to the parts of the first embodiment will be given the same name as the parts of the first embodiment. Moreover, the descriptions of the parts of the second embodiment that are identical or identical in function to the parts of the first embodiment may be omitted for the sake of brevity.

Referring to FIGS. 9 and 10, the vehicle egress aid 110 fundamentally includes a handle member 120 and a locking member 122. The handle member 120 has a gripping portion 132 and a striker engagement portion 134. The locking member 122 further has an actuating portion 164 and a locking portion 166. The locking member 122 prevents the handle member 120 from being removed from the wire loop 16b of the striker 16.

Referring to FIG. 9, the locking member 122 includes a first end portion 122a and a second end portion 122b. The locking portion 166 includes a locking surface 166b2 and a protrusion 166b1. The locking member 122 further has a tether 168. The first end portion 122a of the locking member 122 defines the actuating portion 164 of the locking member 122. The second end portion 122b of the locking member 122 defines the locking portion 166 of the locking member 122.

The locking surface 166b2 is defined by the surface of the second end 122b of the locking member 122 that faces the bridging portion 16b3 of the wire loop 16b. The handle member 120 has a stop surface 156 that faces the wire loop 16b in the installed state. The locking surface 166b2 of the locking portion 166 and the stop surface 156 of the handle member 120 are on opposite sides of the bridging portion 16b3 of the wire loop 16b in the installed state.

The protrusion 166a1 is defined by the second end portion 122b of the locking member 122. The protrusion 166a1 is received by a first opening 150 of the striker engagement portion 134. The protrusion 166a1 locks the locking member 122 to the striker engagement portion 134.

The tether 168 includes a first end portion 168a and a second end portion 168b. The first end portion of the tether 168 is attached to the handle member 120. The second end portion of the tether 168 is attached to the locking member 122. The tether 168 prevents the handle member 120 and the locking member 122 from being separated and lost.

In the locked position of FIG. 9, the protrusion 166b1 of the locking portion 166 is received by the first opening 150 of the striker engagement portion 134. The first end portion 166a of the locking portion 166 extends away from the striker engagement portion 134. The second end portion 166b of the locking portion 166 is received by the first opening 150. The locking surface 166b2 of the locking portion 166 and the stop surface 156 of the handle member 120 are configured to be disposed on opposite sides of the bridging portion 16b3 of the wire loop 16b in the locked position to prevent the striker engagement portion 134 from being removed from within the wire opening 26 in an installed state where the vehicle egress aid 110 is locked to the striker 16.

In the unlocked position of FIG. 10, the user has removed the protrusion 166b1 of the locking portion 166 from the first opening 150 of the striker engagement portion 134. In other words, the protrusion 166b1 is spaced apart from the first opening 150. The tether 168 connects the handle member 120 to the locking member 122 to prevent the locking member 122 from being lost.

### Third Embodiment

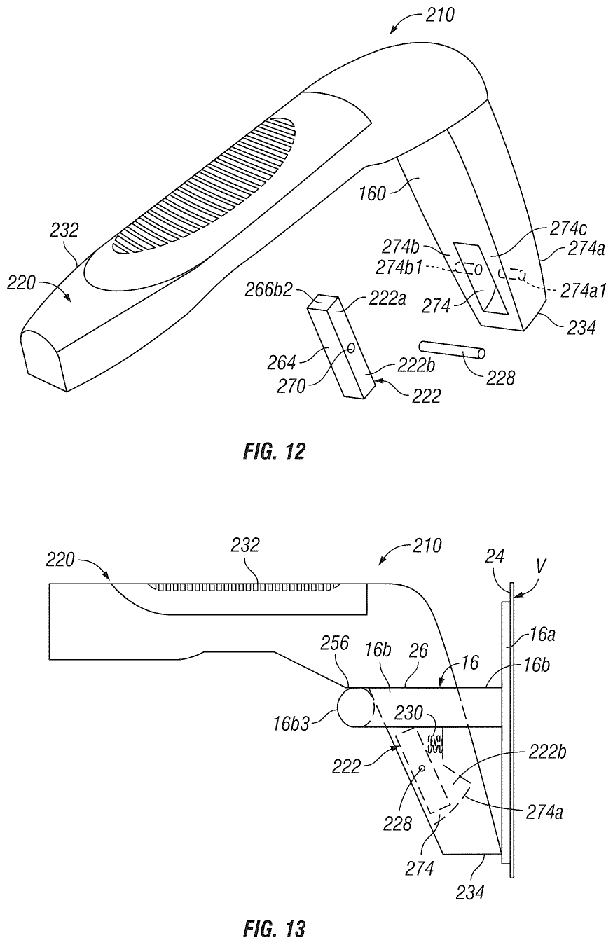

Referring now to FIGS. 11-13, a vehicle egress aids 210 in accordance with a second embodiment will now be explained. The vehicle egress aid 210 is used to engage the striker 16 of the vehicle V in a similar manner as the vehicle egress aid 10 discussed above. In view of the similarity between the first and third embodiments, the parts of the second embodiment that are identical or identical in function to the parts of the first embodiment will be given the same name as the parts of the first embodiment. Moreover, the descriptions of the parts of the third embodiment that are identical or identical in function to the parts of the first embodiment may be omitted for the sake of brevity.

Referring to FIG. 11, the vehicle egress aid 210 fundamentally includes a handle member 220 and a locking member 222. The vehicle egress aid 210 further includes a biasing member 230 configured to bias the locking member 222 towards the locked position. Fundamentally, the locking member 222 is pivotally attached to the handle member 220 by a pivot shaft 228. The handle member 220 has a gripping portion 232 and a striker engagement portion 234. Here, the locking member 222 is pivotally attached to the striker engagement portion 234 of the handle member 220 by the pivot shaft 228. The locking member 222 prevents the striker engagement portion 234 from being removed from the wire loop 16b of the striker 16.

Referring to FIG. 11, the striker engagement portion 234 includes a cavity 274, the locking member 222, a pivot shaft 228 and biasing member 222. The interior surface 160 of the striker engagement portion 234 includes the cavity 274. The cavity 274 is defined by a base wall 274a, a first wall 274b and a second wall 274c. The first wall 274b and the second wall 274c extend away from the base wall 274a.

The locking member 222 includes a first end portion 222a and a second end portion 222b. The locking member 222 further has an actuating portion 264 and a locking portion 266. The locking portion 266 includes a locking surface 266b2. The first end portion 222a is biased away from the striker engagement portion 234 in the locked position. The second end portion 222b extends toward the striker engagement portion 234 in the locked position. A first surface 265 of the locking member 222 is defined by the actuating portion 264 of the locking member 222. A second surface 267 of the locking member 222 is defined by the locking portion 266 of the locking member 222. The locking surface 266b2 is defined by the surface of the locking member 222 that faces the wire loop 16b. More specifically, the locking surface 266b2 is defined by a second end surface of the locking member 222. The second surface 267 corresponds to the locking surface 266b2.

The pivot shaft 228 is received by the first pivot opening 274b1, the second pivot opening 274c1 and the third pivot opening 270. The locking member 222 is configured to pivot in the cavity 274 about the pivot shaft 228 relative to the striker engagement portion 234. Stated differently, the locking member 222 is at least partly located in the cavity 274 between the first wall 274b and the second wall 274c. Alternatively, the pivot shaft 268 can be a single monolithic part with the first wall 274b of the striker engagement portion 234.

The biasing member 230 is disposed between the striker engagement portion 234 and the first end portion 222a of the locking member 222. In other words, the biasing member 230 is disposed between the striker engagement portion 234 and the locking member 222. The biasing member 230 biases the locking member 222 towards the locked position, away from the striker engagement portion 234.

In the locked position of FIG. 11, the biasing member 230 biases the first end portion 222a of the locking member 222 out of the cavity 274. The locking surface 266b2 of the locking member 222 and the stop surface 256 of the handle member 220 are on opposite sides of the striker wire in the installed state. Referring to FIG. 13, to unlock the vehicle egress aid 210, the user pushes the actuating portion 264 of the locking member 222 toward the striker engagement portion 234 to compress the biasing member 230. In the unlocked position of FIG. 13, the user can slide the sticker engagement portion 234 out of the wire opening 26 to disengage the vehicle egress aid 210 from the striker 16.

In understanding the scope of the present invention, the term “comprising” and its derivatives, as used herein, are intended to be open ended terms that specify the presence of the stated features, elements, components, groups, integers, and/or steps, but do not exclude the presence of other unstated features, elements, components, groups, integers and/or steps. The foregoing also applies to words having similar meanings such as the terms, “including”, “having” and their derivatives. Also, the terms “part,” “section,” “portion,” “member” or “element” when used in the singular can have the dual meaning of a single part or a plurality of parts. Also as used herein to describe the above embodiment(s), the following directional terms “forward”, “rearward”, “above”, “downward”, “vertical”, “horizontal”, “below” and “transverse” as well as any other similar directional terms refer to those directions of a vehicle equipped with the vehicle egress aid. Accordingly, these terms, as utilized to describe the present invention should be interpreted relative to a vehicle equipped with the vehicle egress aid.

The terms of degree such as “substantially”, “about” and “approximately” as used herein mean a reasonable amount of deviation of the modified term such that the end result is not significantly changed.

While only selected embodiments have been chosen to illustrate the present invention, it will be apparent to those skilled in the vehicle field from this disclosure that various changes and modifications can be made herein without departing from the scope of the invention as defined in the appended claims. For example, the size, shape, location or orientation of the various components can be changed as needed and/or desired. Components that are shown directly connected or contacting each other can have intermediate structures disposed between them. The functions of one element can be performed by two, and vice versa. The structures and functions of one embodiment can be adopted in another embodiment. It is not necessary for all advantages to be present in a particular embodiment at the same time. Every feature which is unique from the prior art, alone or in combination with other features, also should be considered a separate description of further inventions by the applicant, including the structural and/or functional concepts embodied by such feature(s). Thus, the foregoing descriptions of the embodiments according to the present invention are provided for illustration only, and not for the purpose of limiting the invention as defined by the appended claims and their equivalents.

What is claimed is:

1. A vehicle egress aid comprising:
a handle member having a gripping portion and a striker engagement portion, the striker engagement portion being configured to be received within a wire loop of a striker; and
a locking member having an actuating portion and a locking portion, the locking portion having a locking surface, the locking member being movably coupled relative to the handle member between a locked position and an unlocked position;
the locking surface of the locking portion and the handle member being configured to be disposed on opposite sides of the wire loop in the locked position to prevent the striker engagement portion from being removed from within the wire loop in an installed state where the vehicle egress aid is locked to the striker.

2. The vehicle egress aid according to claim 1, wherein
the striker engagement portion has a stop surface configured to contact the striker in the locked position.

3. The vehicle egress aid according to claim 2, wherein
the stop surface is configured to contact an upper surface of a bridging portion of the striker, and the locking surface is configured to face a lower surface of the bridging portion of the striker in the locked position in the installed state.

4. The vehicle egress aid according to claim 3, wherein
the locking surface is configured to contact the lower surface in the locked position in the installed state.

5. The vehicle egress aid according to claim 1, wherein
the locking portion is spaced apart from the striker engagement portion in the unlocked position.

6. The vehicle egress aid according to claim 1, wherein
the striker engagement portion has a first opening to receive a protrusion of the locking portion.

7. The vehicle egress aid according to claim 1, wherein
the striker engagement portion extends transversely to the gripping portion, and the handle member has a second opening extending transversely to the gripping portion.

8. The vehicle egress aid according to claim 1, wherein
the locking member is pivotally mounted relative to the handle member on a pivot shaft between the locked position and the unlocked position.

9. The vehicle egress aid according to claim 1, wherein
the gripping portion has a cavity configured to at least partially receive the actuating portion in the locked position.

10. The vehicle egress aid according to claim 8, wherein
the gripping portion has a base wall and a first wall extending from the base wall to define a cavity that is configured to at least partially receive the actuating portion in the locked position, the first wall has a first pivot opening, and the locking member has a third pivot opening, the pivot shaft is disposed in the first pivot opening and the third pivot opening.

11. The vehicle egress aid according to claim 10, wherein
the gripping portion has a second wall extending from the base wall to further define the cavity, the second wall has a second pivot opening, the pivot shaft is disposed in the second pivot opening.

12. The vehicle egress aid according to claim 1, wherein
the locking portion is spring biased toward the striker engagement portion.

13. The vehicle egress aid according to claim 1, further comprising
a biasing member biasing the actuating portion away from the gripping portion.

14. The vehicle egress aid according to claim 1, wherein
the locking member having a tether having a first end portion and a second end portion, the first end portion is attached to the locking member, the second end portion is attached to the handle member.

15. A vehicle comprising a vehicle egress aid according to claim 1, and further comprising:
a vehicle body having a door opening, the striker is attached to the vehicle body within the door opening.

16. The vehicle according to claim 15, wherein
the vehicle body has an upright surface partially defining the door opening, the striker has a mounting plate attached to the upright surface, the wire loop extends toward an interior of the door opening.

17. The vehicle egress aid according to claim 1, wherein
the striker engagement portion has an interior surface and an exterior surface, the exterior surface is configured to engage the mounting plate and the interior surface is configured to engage the wire loop where the locking member is in the locked position.

18. The vehicle egress aid according to claim 1, wherein
the gripping portion and the striker engagement portion have an overall L shape.

19. The vehicle egress aid according to claim 1, further comprising
a biasing member disposed between the handle member and the locking member.

20. The vehicle egress aid according to claim 1, further comprising
a biasing member disposed between the striker engagement portion and the locking member, the biasing member biases the locking member towards the locked position. away from the striker engagement portion.
